(19) United States
(12) Patent Application Publication
(10) Pub. No.: US 2022/0049833 A1
(43) Pub. Date: Feb. 17, 2022

(54) IMPROVED ILLUMINATION DEVICE

(71) Applicant: NAMENE SOLAR LIGHTS LIMITED, London (GB)

(72) Inventor: Massimo LISANTI, London (AE)

(21) Appl. No.: 17/274,701

(22) PCT Filed: Aug. 22, 2019
(86) PCT No.: PCT/GB2019/052364

§ 371 Date: Mar. 9, 2021

(30) Foreign Application Priority Data
Sep. 10, 2018 (GB) 1814687.8

(51) Int. Cl. F21V 3/06; F21S 9/03

(52) U.S. Cl. CPC F21V 3/0615; F21Y 2115/10; F21S 9/035

(57) ABSTRACT

An illumination device, which comprises a light source and a battery to power the light source, provides improved light output without the need for complicated and therefore expensive optical arrangements by including a nonimaging light guide which collimates and optionally diffuses light emitted by the light source. In a particular embodiment of the invention these improvements are implemented in a multipurpose solar light which includes a solar panel, wherein the battery stores energy generated by the solar panel. The illumination device may comprise a casing having a front casing portion and a rear casing portion, wherein the nonimaging light guide is integrally formed with the front casing portion. The nonimaging light guide may have a shape comprising two conical frusta. Furthermore, the nonimaging light guide may comprise a recess in which the light source is located, the recess being larger than the light source such that there is a gap which permits airflow and in turn removal of heat from the light source as well as improved optical coupling.

The present invention relates to the field of illumination devices such as hand-held torches, freestanding lights and headtorches. More specifically, the present invention concerns improvements to illumination devices which results in improved light output without the need for complicated and therefore expensive optical arrangements. In a particular embodiment of the invention these improvements are implemented in a multipurpose solar light.

### BACKGROUND TO THE INVENTION

In sub-Sahara Africa there are an estimated 620 million people who are living without access to electricity. As a result, many Africans rely upon kerosene lamps for lighting. Unfortunately, kerosene lamps are dangerous and polluting, costly to run, and above all are a health risk to those who use them, particularly in domestic settings.

In an attempt to eliminate the need for kerosene lamps for lighting, and to meet the needs of the 1.2 billion people worldwide who have no access to electricity, the Applicant's SM100 solar light was developed. This device incorporates a photovoltaic panel which charges an internal battery during the day and a light, powered by the battery, which provides a wide distribution of light at night or when otherwise required.

The SM100 solar light provides a sustainable lighting solution which has been proven to improve the lives of human beings, taking advantage of pollution free electricity generated by the sun. Children are enabled to study and feel safe after dark, parents can work to earn an income or indeed increase their income after the sun sets, there is no need to purchase expensive kerosene, and it increases safety when working, walking or cycling after dark.

Despite the many and varied uses of the SM100 solar light which has proved transformative for so many people, the Applicant continues to seek ways to improve it and other similar devices. Accordingly, it is an object of at least one aspect of the present invention to improve upon the SM100 solar light, and to obviate and/or mitigate one or more disadvantages of other known/prior solar lights, in particular to provide additional benefits to users.

Further aims and objects of the invention will become apparent from reading the following description.

### SUMMARY OF THE INVENTION

According to a first aspect of the invention, there is provided an illumination device comprising a solar panel, a light source, a battery configured to store energy generated by the solar panel and to power the light source, and a nonimaging light guide configured to collimate light emitted by the light source (or which collimates light emitted by the light source).

The nonimaging light guide avoids forming an image of the light source on a subject illuminated by the illumination device, while optimising radiative transfer from the light source to the subject.

Preferably, the nonimaging light guide is configured to collimate and diffuse light emitted by the light source (or collimates and diffuses light emitted by the light source).

Preferably, the nonimaging light guide is generally frusto-conical in shape. Most preferably, the nonimaging light guide has a shape which comprises two or more conical frusta. Preferably, the nonimaging light guide comprises a plastic material such as ABS and/or polycarbonate.

Preferably, the nonimaging light guide comprises a recess, and the light source is located within the recess. Preferably, the recess is larger than the light source such that a gap is defined between the light source and the nonimaging light guide.

Preferably, the light source comprises one or more LEDs.

Preferably, the solar panel is a polycrystalline or monocrystalline solar photovoltaic panel.

Preferably, the battery is rechargeable. Preferably, the battery comprises a lithium iron phosphate battery.

Preferably, the illumination device comprises a casing. Preferably, the nonimaging light guide is integrally formed with the casing.

Optionally, the casing comprises a front casing portion and a rear casing portion. Preferably, the front casing portion is at least partially transparent or translucent. Preferably, the nonimaging light guide is integrally formed with the front casing portion. Optionally, the front casing portion is frosted. Optionally, an outer face of the front casing portion is regressed or recessed, preferably only slightly, and preferably only in the region of the nonimaging light guide.

Preferably, the casing comprises ABS and/or polycarbonate. Preferably, the casing comprises a flame retardant and or heat resistant material. Preferably, the casing is water resistant.

Optionally, the illumination device comprises a stand. The stand may be shaped to permit the illumination device to be hung on a wall.

Optionally, the illumination device comprises means to attach a lanyard or a strap, such as a hand strap or a head strap. The illumination device may therefore comprise one or more slots.

Preferably, the illumination device comprises a switch.

In a preferred embodiment of the first aspect, the illumination device comprises a casing having a front casing portion and a rear casing portion, wherein the nonimaging light guide is integrally formed with the front casing portion and has a shape comprising two conical frusta, and wherein the nonimaging light guide further comprises a recess in which the light source is located, the recess being larger than the light source such that a gap is defined therebetween.

This preferred embodiment may further comprise any of the foregoing preferred or optional features of the first aspect.

Furthermore, embodiments of the first aspect of the invention may comprise features corresponding to the preferred or optional features of any other aspect of the invention or vice versa.

According to a second aspect of the invention there is provided a method of manufacturing an illumination device comprising a housing and a light source, the method comprising integrally forming a nonimaging light guide in the housing.

Embodiments of the second aspect of the invention may comprise features corresponding to the preferred or optional features of any other aspect of the invention or vice versa. For example, the method may further comprise locating the light source within a recess in the nonimaging light guide.

According to a third aspect of the invention, there is provided an illumination device comprising a light source, a battery to power the light source, and a nonimaging light guide to collimate light emitted by the light source (or which collimates light emitted by the light source).

Preferably, the nonimaging light guide is configured to collimate and diffuse light emitted by the light source (or collimates and diffuses light emitted by the light source).

Embodiments of the third aspect of the invention may comprise features corresponding to the preferred or optional features of any other aspect of the invention or vice versa. For example, the illumination device may further comprise a solar panel and the battery may be configured to store energy generated by the solar panel.

### BRIEF DESCRIPTION OF THE DRAWINGS

There will now be described, by way of example only, embodiments of the invention with reference to the drawings (like reference numerals being used to denote like features), of which:

FIG. 1 illustrates a solar light in accordance with at least one aspect of the invention viewed in perspective from (a) the rear and (b) the front;

FIG. 2 is a schematic cross-section through the solar light illustrated in FIG. 1 showing relevant internal details; and

FIG. 3 is a perspective rear view of the front casing of the solar light illustrated in FIG. 1 separated from the back panel.

Note that the drawings are not necessarily to scale, certain parts may have been omitted and the proportions of certain parts may have been exaggerated to better illustrate details and features of embodiments of the invention.

### DETAILED DESCRIPTION OF PREFERRED EMBODIMENTS

As discussed in the background to the invention above the Applicant's existing SM100 solar light, like other similar solar lights, provides a wide distribution of light. While in some applications this is desirable, it is recognised that there can be significant light wastage (a surface mounted LED typically emits light over 180 steradians). In some applications, a wide distribution of light may be undesirable.

The present invention seeks to improve on such solar lights (and other illumination devices) and the following description of a preferred embodiment thereof will assist in understanding how this improvement has been achieved.

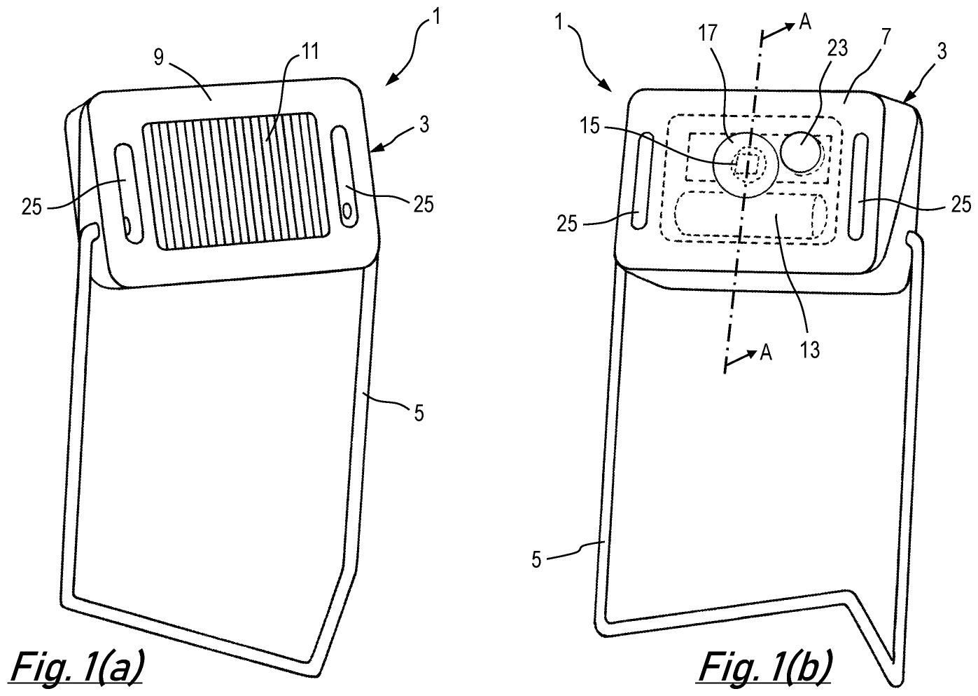

FIGS. 1 to 3 illustrate in various views a solar light 1 and various parts thereof. The solar light 1 comprises a casing 3 and a removable stand 5. The removable stand 5 is an optional but useful feature which not only allows the solar light 1 to stand above a surface but also allows the solar light 1 to be hung on a wall for example. The casing 3 comprises a front casing portion 7 and a rear casing portion 9.

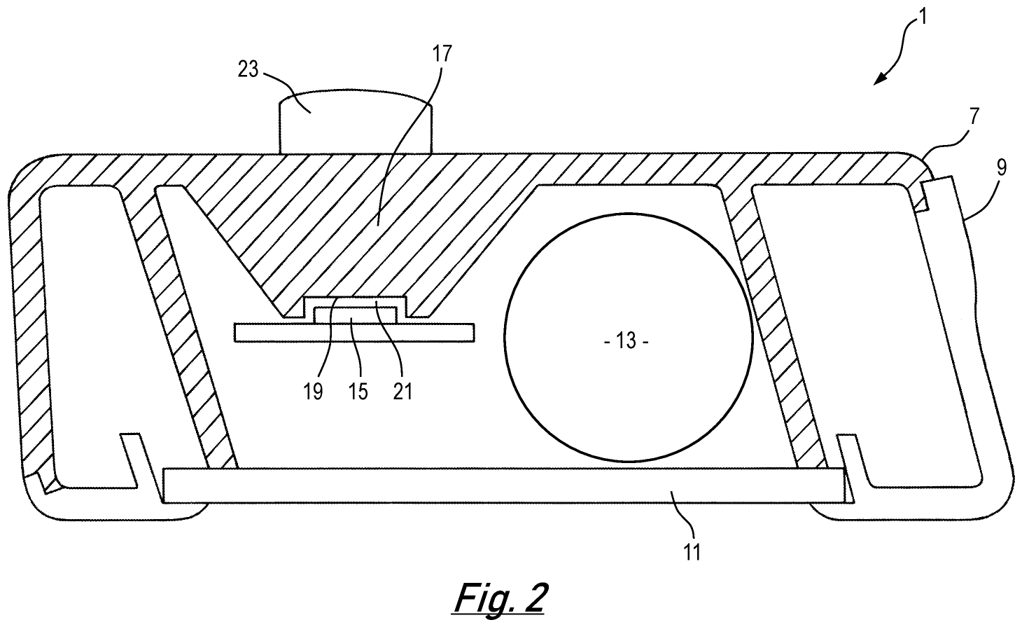

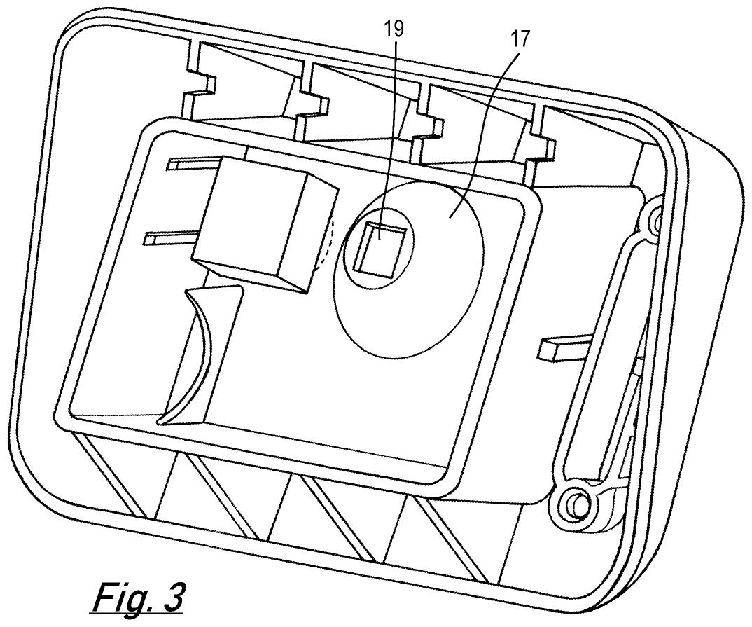

The front casing portion 7 is shown in FIG. 3 removed from the rear casing portion 9 to show relevant internal components which are also made evident in the cross-section through A-A of FIG. 1(b) shown in FIG. 2. In this embodiment the front casing portion 7 is transparent but frosted to diffuse light, however it could alternatively be translucent.

In this embodiment the front casing portion 7 and the rear casing portion 9 are screwed together, but other arrangements are envisaged such as clips, and the material of the casing 3 is ABS plastic which lends the casing favourable mechanical properties such as impact resistance, toughness and heat resistance. Alternatively, or additionally, the material of the casing can be polycarbonate, although any suitable material can be employed provided the front casing portion 7 (or at least a portion thereof) is light transmissive.

The rear of the solar light 1 can be seen to comprise a solar panel 11, which in this embodiment is a 4.5 V, 68 mA polycrystalline silicon solar panel. Internal to the casing 3, as denoted by dashed lines in FIG. 1(b), is a rechargeable battery 13, which in this embodiment is a 3.2 V, 400 mAh lithium iron phosphate (LiFePO₄) battery. The battery 13 stores energy generated by the solar panel 11, and also powers the light source 15, which in this embodiment is a single, surface mounted device (SMD) LED, with a power of 0.5 W and a white-blue light. A switch 23 is provided to enable a user to turn the light source 15 on and off with two light settings.

Referring to FIGS. 2 and 3, in which the relevant internal features are more clearly visible, the solar light 1 further comprises a nonimaging light guide 17. A nonimaging light guide optimises radiative transfer from a source to an object or surface without forming an image of the source, as compared with typical optical arrangements in which an image (real or imaginary) is formed. Accordingly, the use of nonimaging light guide 17 has the significant advantage that it collimates light from the light source 15 but without projecting a specular image of the light source 15 onto the subject of the illumination.

In this embodiment the nonimaging light guide 17 is integrally formed with the front casing portion 7 but it could be a separate component affixed to the front casing portion 7 and or to the light source 15.

The nonimaging light guide 17 is substantially frusto-conical in shape and in this embodiment the shape actually corresponds to two conical frusta. It can also be seen to comprise a recess 19 which is of a similar shape to the light source 15 which is located in the recess 19. Locating the light source 15 in the recess 19 has the advantage of improving the collection of light from the light source 15.

As is evident from FIG. 2 in particular, the recess 19 is larger than the light source 15 to the extent that a gap or channel 21 is provided therebetween. This gap or channel 21 permits airflow which in turn allows removal of heat from the light source 15. A further benefit of the gap or channel 21 is that light is more effectively coupled into the nonimaging light guide 17 than if the light source 15 simply abutted the nonimaging light guide 17.

Independent testing has shown that the addition of the nonimaging light guide 17 described above increases the illuminance achieved (compared to an equivalent solar light without the nonimaging light guide) by more than 50%.

Furthermore, being able to provide a sufficiently diffuse and collimated beam of light from a solar light (or indeed any illumination device) is desirable in a number of applications. For example, when used as a hand torch it permits more directional illumination and hence a greater intensity of light on the subject of illumination. In one application, it might enable devices such as the SM100 and other similar solar lights to more effectively illuminate a path when walking or cycling at night.

Notably, that the nonimaging light guide 17 can be integrally formed with the casing 3 also has significant advantages in relation to manufacture. Rather than having to incorporate lenses or other components within the solar light (or other illumination device) a mould from which the casing 3 or the front casing portion 7 is produced can simply include a portion to form the nonimaging light guide 17. Such an arrangement also avoids the need for moving parts and negligible incremental production and material costs. The integral manufacturing of the casing with the nonimaging light guide saves considerable cost compared to being manufactured independently. Cost is a key driver of adoption of pico-solar lights for families on incomes below the poverty line.

Note that in an alternative embodiment, the outer face of the front casing portion can be regressed or recessed. This can be in the region of the nonimaging light guide only, and it is advantageous if it is only slightly regressed or recessed to avoid dirt build-up that might otherwise obscure light propagation.

The solar light 1 is also provided with a pair of elongate slots 25 which extend through the casing 3 to permit attachment of a strap or a lanyard (not shown), such as may be used to affix the solar light 1 to a user's head or hand.

It will of course be apparent that features and advantages of the illumination device described herein are not limited to solar lights but are applicable to illumination devices which do not incorporate a solar cell. As such it is envisaged that the nonimaging light guide described herein may be incorporated in, for example, battery-powered hand-held torches, freestanding lights and headtorches, without departing from the scope of the invention.

The invention provides an illumination device, which comprises a light source and a battery to power the light source, and provides improved light output without the need for complicated and therefore expensive optical arrangements by including a nonimaging light guide which collimates and optionally diffuses light emitted by the light source. In a particular embodiment of the invention these improvements are implemented in a multipurpose solar light which includes a solar panel, wherein the battery stores energy generated by the solar panel. The illumination device may comprise a casing having a front casing portion and a rear casing portion, wherein the nonimaging light guide is integrally formed with the front casing portion. The nonimaging light guide may have a shape comprising two conical frusta. Furthermore, the nonimaging light guide may comprise a recess in which the light source is located, the recess being larger than the light source such that there is a gap which permits airflow and in turn removal of heat from the light source as well as improved optical coupling.

As may be used herein, the terms bottom, back, lower, below and the like are descriptive of a feature that is located towards a first end/side of an apparatus, system or component while the terms top, front, upper, above and the like are, respectively, descriptive of a feature that is located towards a second, opposing end/side of the apparatus, system or component. Such an apparatus, system or component may be inverted without altering the scope of protection which, as below, is defined by the appended claims.

Throughout the specification, unless the context demands otherwise, the terms “comprise” or “include”, or variations such as “comprises” or “comprising”, “includes” or “including” will be understood to imply the inclusion of a stated integer or group of integers, but not the exclusion of any other integer or group of integers. Furthermore, unless the context clearly demands otherwise, the term “or” will be interpreted as being inclusive not exclusive.

The foregoing description of the invention has been presented for the purposes of illustration and description and is not intended to be exhaustive or to limit the invention to the precise form disclosed. The described embodiments were chosen and described in order to best explain the principles of the invention and its practical application to thereby enable others skilled in the art to best utilise the invention in various embodiments and with various modifications as are suited to the particular use contemplated. Therefore, further modifications or improvements may be incorporated without departing from the scope of the invention as defined by the appended claims.

1. An illumination device comprising a solar panel, a light source, a battery configured to store energy generated by the solar panel and to power the light source, and a nonimaging light guide which collimates light emitted by the light source.

2. The illumination device of claim 1, wherein the nonimaging light guide collimates and diffuses light emitted by the light source.

3. The illumination device of claim 1, wherein the nonimaging light guide is generally frusto-conical in shape.

4. The illumination device of claim 3, wherein the nonimaging light guide has a shape which comprises two or more conical frusta.

5. The illumination device of claim 1, wherein the nonimaging light guide comprises a recess, and the light source is located within the recess.

6. The illumination device of claim 5, wherein the recess is larger than the light source such that a gap is defined between the light source and the nonimaging light guide.

7. The illumination device of claim 1, wherein the light source comprises one or more LEDs.

8. The illumination device of claim 1, wherein the solar panel is a polycrystalline or monocrystalline solar photovoltaic panel.

9. The illumination device of claim 1, wherein the battery comprises a lithium iron phosphate battery.

10. The illumination device of claim 1, wherein the illumination device comprises a casing and the nonimaging light guide is integrally formed with the casing.

11. The illumination device of claim 10, wherein the casing comprises a front casing portion and a rear casing portion.

12. The illumination device of claim 11, wherein the front casing portion is at least partially transparent or translucent, or wherein the front casing portion is frosted.

13. The illumination device of claim 11, wherein the nonimaging light guide is integrally formed with the front casing portion.

14. The illumination device of claim 11, wherein an outer face of the front casing portion is regressed or recessed in the region of the nonimaging light guide.

15. The illumination device of claim 1, wherein the casing and/or the nonimaging light guide comprises ABS and/or polycarbonate.

16. The illumination device of claim 1, wherein the illumination device comprises a switch.

17. The illumination device of claim 1, comprising a casing having a front casing portion and a rear casing portion, wherein the nonimaging light guide is integrally formed with the front casing portion and has a shape comprising two conical frusta, and wherein the nonimaging light guide further comprises a recess in which the light source is located, the recess being larger than the light source such that a gap is defined therebetween.

18. A method of manufacturing an illumination device comprising a housing and a light source, the method comprising integrally forming a nonimaging light guide in the housing.

19. An illumination device comprising a light source, a battery to power the light source, and a nonimaging light guide which collimates light emitted by the light source.

20. The illumination device of claim 19, wherein the nonimaging light guide collimates and diffuses light emitted by the light source.
